(19) United States
(12) Patent Application Publication
(10) Pub. No.: US 2004/0006765 A1
(43) Pub. Date: Jan. 8, 2004

(54) Live software construction with dynamic classes

(76) Inventor: Kenneth J. Goldman, Clayton, MO (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/414,670

(22) Filed: Apr. 16, 2003

Related U.S. Application Data
(60) Provisional application No. 60/373,855, filed on Apr. 16, 2002.

(51) Int. Cl. G06F 9/44

(52) U.S. Cl. 717/116; 717/109

(57) ABSTRACT

A system for software development provides an underlying object-oriented programming language and a language front-end supporting software development in a programming methodology of the object-oriented programming language, the system providing a graphical programming environment permitting access to classes of the object-oriented programming language and permitting subclasses to be defined and modified dynamically (“dynamic classes”) while the software under development is executing. Modifications to the dynamic classes can be reflected in future instances of the classes and in instances of the classes existing prior to the changes. In one embodiment, the object-oriented programming language is Java. The dynamic classes coexist with compiled classes of the object-oriented programming language, the dynamic and compiled classes each being capable of calling methods on instances of any class. The dynamic classes may be created as subclasses of other dynamic classes or of compiled classes (“parent classes”) and may selectively override methods of the parent class.

### RELATED APPLICATIONS

This application claims benefit of U.S. Provisional Application Serial No. 60/373,855, filed Apr. 16, 2002, entitled, “LIVE SOFTWARE CONSTRUCTION WITH DYNAMIC CLASSES.”

### FIELD OF THE INVENTION

The present invention relates generally to software development, and more particularly to a method and system for creating software using a visual rather than textual representation, further providing that program modifications be made while the program is running.

### BACKGROUND OF THE INVENTION

Creating tools for efficient software development has been a longstanding goal of computer science, starting from the first compilers and continuing to today's visual languages and integrated development environments (IDEs). Significant progress has been made, but the fact remains that custom software construction, even for relatively small applications, is a slow and difficult process, successfully accomplished only by people with substantial training and experience. Moreover, in spite of advances in software development tools, formal training of competent programmers remains a labor-intensive and time-consuming task. Introductory programming courses continue to be ‘rites of passage’ in which only those who are willing to contend with a steep learning curve in an artificial syntax survive. The end result is that few people have ever been exposed to the idea of software construction, and fewer still have actually built an application. If we are serious about putting the power of general-purpose programming into the hands of more people, then we need to be serious about creating software tools that enable people to create software in ways that are attractive, comfortable, efficient, and reliable.

Background Definitions

This invention concerns tools for the simplification of object-oriented software construction. An object-oriented programming language is one in which each component of a software system is an object, which is an instance of a class. A class may be thought of as a definition of a type of object, and each instance of the class is said to belong to that type. Each class provides one or more constructors for creating instances of that class. Each object, in accordance with its class definition, contains instance variables for storing information and methods for accessing and operating on that information. Each method may be defined to accept parameter values, which provide additional information to the method when it executes. Each method may optionally contain local variables that are used to store the results of intermediate computations, a method body that contains a sequence of steps (or statements) to be carried out by the method, and a return statement that determines the value to be returned as the result of when the method completes. Classes may be extended to create subclasses that inherit methods of the class. A subclass definition may include additional methods and/or override inherited methods in order to achieve more specialized behavior. Object-oriented programming languages are traditionally textual languages. A text editor is used to write the source program which is subsequently compiled or interpreted for execution. When one or more classes need to be modified, the source code typically must be changed, and the execution must be restarted from the beginning, possibly using any information that the previous execution might have saved in one or more files.

Further Background and Motivation for the Invention

Successful tools scale. They allow novice users to get started quickly, and they support experienced users in more sophisticated tasks. However, tools for software development generally do not scale well from novice to expert. Instead, software tools appear to be targeted to one of two groups. Either they are written “by programmers for programmers,” in which case the user is assumed to have a significant amount of experience, or they are written “by programmers for non-programmers,” in which case the expectation is that the user is not (and never will be) a programmer, and therefore does not need a “real” programming language, but instead a “toy” programming language suitable for building only simple applications. Non-programmers who attempt to build an application using a tool designed for programmers must be relatively determined and have the patience for a great deal of self-teaching. On the other hand, individuals who gain some experience in a tool for non-programmers and later wish to develop serious applications are likely to discover that their “toy” language doesn't adequately support the task. In that case, they will need to abandon their first tool for a “professional” one, giving up the familiarity of the tool and, more importantly, the software development methodology they have learned within it.

Integrated Development Environments (IDEs)

Today's integrated development environments (IDEs) generally fall into the “by programmers for programmers” category. Such systems are umbrella applications, combining an editor, compiler, run-time system, and debugger all under one roof. For example, IDEs supporting software development in Java include Inprise (Borland) JBuilder, Sun's Forte for Java, NetBeans, IBM VisualAge for Java, Webgain (Symantec) Visual Café, and Metrowerks Code Warrior, among others. Many of these environments provide programmer support, including a GUI builder that permits rapid specification of the layout of the graphical user interface. Construction of the GUI is usually “live” so changes in relationships between the GUI and the underlying data model are reflected instantly. However, all of these systems are built on the assumption that, in the end, the underlying functionality of a truly custom application is written in a textual language by an experienced programmer who is familiar with the syntax of the language and is adept at understanding compilation errors and tracking down program errors. To support writing code in the textual language, these environments provide source code editors with helpful features like text colorizing and method name completion. When compile time or run-time errors occur, these environments provide help in navigating the code to quickly locate the offending line of text. But these features, although handy for programmers, are of little help to the individual without programming experience.

Visual Languages

Visual languages are designed for programming environments in which software is constructed by direct manipulation of graphical language primitives and operators. They are typically new languages (as opposed to graphical front-ends for existing languages), and they are generally based on execution models that are deemed to be particularly well suited for visual expression. Usually, these languages provide a tight integration of editing and program execution, and in some cases the program can be edited “live,” while it is running.

Most visual languages are at the other end of the spectrum, in the category of “by programmers for non-programmers.” Many visual languages have been constructed using a variety of paradigms. One of the most common paradigms is dataflow, in which data flows across “arrows” to trigger actions performed in “boxes.” Some examples of dataflow visual languages are Show and Tell, one of the first dataflow visual languages, designed to be accessible to children; Prograph, which has been developed commercially; Khoros, which has been targeted for image and signal processing; and our own distributed application configuration language. However, visual languages use other paradigms as well. Forms/3 introduces procedural abstraction within a declarative programming spreadsheet paradigm. ThingLab uses a constraint-oriented paradigm to support the construction of geometric models. Statecharts supports software development with a nested state-machine paradigm. VIPR uses arrows and nested rings to declare program behavior with elements of object-oriented programming. AgentSheets provides a rule-based paradigm for specifying how interacting agents gather and process information. Stagecast (a commercial realization of KidSim and Cocoa uses a combination of rule-based programming and programming-by-example to support children in developing video games and simulations.

Sometimes, visual languages are described as “cute toys,” but many visual languages have been successful, both academically and commercially, particularly when the language supports application development in a specialized domain. However, for general-purpose programming, professional software developers have preferred textual languages over visual languages because the expressive power and scalability of textual languages provides more flexibility. For this reason, colleges and universities generally have not adopted visual languages as a means to introduce students to programming and computer science. This could be partly because the faculty do not consider them “real” programming languages, but more likely it is because the thought process involved in constructing programs within visual languages is so strikingly different from that of the more widely-used textual languages that it would be difficult to justify asking students to devote significant time and effort to learn these visual paradigms only to abandon them later.

Neither IDEs nor visual languages are very successful at serving the novice user who wants a smooth upgrade path into the world of professional programmers. A fresh approach to programming environments is needed. Rather than targeting an environment to either “programmers” or “non-programmers,” we maintain that thinking of a programming environment as being written “by programmers for new programmers” has the best chance of giving rise to significant advancement in both programmer productivity and computer science education and outreach. If we design environments not only to enable novice programmers to achieve early success, but also that grow with these budding programmers as they gradually become more sophisticated, then two important gains are achieved. First, we will have created a situation in which the concepts and tools individuals learn while creating their first simple programs will continue to apply when they begin scaling up to practical applications. Second, potential users of the environment will be able to expect that their effort in learning these concepts is likely to pay off in their professional productivity over the long term. Therefore, they will have the incentive to invest the time in the first place. As a result, we need to provide an environment that supports not only the creation of simple applications, but also the construction of practical software that fulfills real information processing needs. Furthermore, we want the development process to be consistent with professional practice. We believe that having such an environment is a critical ingredient in any outreach effort that seeks to bring the power of general-purpose computing to a larger population.

The present invention incorporates not a new language (visual or otherwise), but something that we call a language front-end. This idea is based upon the following observations. First, we recognize that modem textual programming languages have evolved over the entire history of computing. The success of high-level languages like Fortran, C, Pascal, Smalltalk, Lisp, C++, and Java is primarily attributable to their support of abstractions that make the programming process more natural and that can be mapped, by a compiler or interpreter, to efficient execution. Procedural abstraction, parameters and return values, abstract data types, encapsulation, iterators, objects, methods, class hierarchies, inheritance, and polymorphism are examples of abstractions that have driven the evolution of high-level languages. These abstractions transcend programming languages. They support programming models that allow people to think about computations at a higher level. Each high-level language provides constructs for expressing the abstractions in its programming model. Constructs are designed to provide compact and unambiguous expression of these abstractions in a way that is both readable by humans and efficiently processed by a compiler. At the same time, we recognize that textual languages are too open-ended and error-prone for the inexperienced user, so an environment that exposes a novice user to a text editor and compiler is likely to meet only limited success. The goal is how to get the best of both worlds: the accumulated experience embodied in modern textual languages and the user-friendliness of non-textual programming. In achieving this goal, a key observation is that the set of abstractions, not the particular linguistic mechanisms, that account for the success of high-level languages. Our approach develops a language front-end that gives its users the powerful semantics of an underlying textual language, yet delivers that power within the relative comfort of a graphical user interface that supports working directly with the abstractions provided by that language. In other words, we advocate not designing a new language, but instead putting a sensible face on an existing general-purpose language.

However, a “pretty new face” is not enough by itself. Users are accustomed to interactive software applications in which user actions result in immediate and appropriate feedback. For example, the days of running word processing commands through a text formatter are over for most users; they expect an interactive WYSIWYG experience with relevant and timely feedback. Consequently, the write-compile-execute separation, with its delayed and seemingly-obscure error messages, can be a surprising and unwelcome paradigm for novice programmers, and it wastes precious time for even the most experienced. Novice programmers expect the programming experience to be live, so they can modify the program dynamically during its execution. Therefore, there is a need in the art to develop a language front-end for a powerful underlying textual language, and couple it with a run-time system that supports live software construction. The present invention satisfies this need.

### SUMMARY OF THE INVENTION

The present invention discloses a novel visual programming environment that lets people build entire applications interactively while harnessing the power of a modern object-oriented programming language. The present invention supports live software development in which all aspects of a program's behavior can be modified while the program runs, without the write-compile-execute cycle that routinely bogs down software development. The environment enables first-time programmers to achieve early success, without the steep learning curve that typically precedes development in a traditional textual language. At the same time, the environment transparently exposes the capabilities of the underlying programming language so that more experienced developers can leverage object-oriented software development techniques.

The present invention intersects programming languages, user interfaces, visual languages, programming environments, and run-time systems, and is directed toward the development of language front-ends that provide their users with the powerful semantics of a proven underlying textual language, yet delivers that power within the relative comfort of a graphical user interface. Language front-ends promise to transform the way people think about general-purpose programming and to make the power of software creation accessible to a much wider and more diverse population. The present invention has the potential for significant and immediate impact in both programmer productivity and education.

As discussed, the present invention develops a better union between programming languages, run-time systems, and human-computer interfaces to construct a new kind of programming environment having the following aspects and features:

1. Scalability. The environment must support the construction of simple applications by novice programmers, as well the construction of sophisticated software systems. The tool must support, not limit, growth and creativity.

2. A Language Front-End For a Modern Object-Oriented Textual Language. The underlying language must be sufficiently well-developed to support the development of a wide range of sophisticated applications using modern object-oriented design techniques.

3. Semantic Transparency. The language front-end must support the same programming methodology as the underlying language so that users may leverage the power of the underlying language, including access to compiled classes and libraries.

4. Live Software Construction. The environment must support the dynamic modification of classes during program execution, and those modifications must affect not only new instances of the classes, but also existing instances.

5. Interoperability with Compiled Code. Instances of dynamically modifiable classes must interact seamlessly with instances of traditional compiled classes. Instances of dynamically modifiable classes must be able to create instances of compiled classes, and access their fields and methods. Moreover, when dynamically modifiable classes extend compiled classes and override their methods, compiled classes must be able to call the dynamically modifiable methods polymorphically.

6. Enactive Declaration and Use. In keeping with accepted user-interface design philosophy, direct manipulation should be used wherever possible, in place of indirect commands and textual identifiers. Directly grabbing or selecting types, methods, and variables prevents ambiguity, avoids name conflicts, and eliminates masking. Ideally, textual names should be used solely for documentation purposes.

7. Semantic Visibility. Properties of expressions, such as the scope and type of variables and expected parameters of method calls, must be readily visible to the user. This design goal, together with the previous one, saves users from the need to retain a mental map from identifiers to information about their targets.

8. Spatial Consistency. Each kind of programming activity must occur in a consistent position in the interface. For example, instance variables are declared in one place, a method's parameters in another. We expect this to increase code organization, improve user familiarity, and speed up the learning curve.

9. Syntactic Consistency. The language front-end must make it impossible for the user to express anything that is syntactically incorrect. In addition, type mismatch errors must be obviously and immediately flagged so users can correct them while still focused on the offending expression.

10. Learning Curve Management. The tool must be designed with the user's learning curve in mind. This has obvious implications for system usability and documentation, and deeper implications for the way the environment is structured to support developers with a wide range of experience. The environment must simplify the common case, providing streamlined support for programming tasks that are common to many applications, such as automatic creation of accessor methods, handling common user events, creating periodic threads, and layout of typical graphical user interfaces. At the same time, the environment must support the construction and deployment of sophisticated customized applications using arbitrary designs, such as those involving specialized threads, custom event handlers, and custom graphics. The goal is to accomplish this without confusing the novice or irritating the professional.

11. Transitional Support. Scalability dictates that users must be able to grow up within the tool, rather than outgrow the tool. However, we must recognize that any tool, however supportive, has its limitations. Furthermore, there is clear educational value in being able to write programs directly in the underlying language. Therefore, it is incumbent upon us to design the tool in such a way as to provide a migration path so that programmers can make a smooth transition into the underlying language. This begins with semantic consistency, but does not end there.

The present invention is directed to a fresh approach to supporting the programming process, by raising a level of abstraction by treating the programming process as an application domain. This accordingly results in elevating the unit of discourse for software construction by providing direct manipulation of semantic elements, so that programming abstractions become the primitives of expression. In turn, this enables a transition from loosely-coupled umbrella IDEs to tightly integrated development environments (TIDEs), in which awareness of program structure creates tremendous opportunities for ensuring program consistency and supporting truly live software development.

Treating programming as an application domain leads to direct manipulation of domain-specific entities. While visual languages have produced systems supporting direct manipulation of program entities, visual languages are focused on new ways to think about computation that is particularly well-suited for visual expression. The present invention provides application-level support for already widely accepted programming practices. Rather than create new languages, the present invention applies human-computer interface design principles to the problem of providing domain-specific support for programming in existing high-level languages.

Elevating the domain of discourse in program construction includes having abstractions used in object-oriented program design become the manipulated units, rather than the characters that describe them. Elevating the unit of discourse accomplishes at least two main goals. First, the programmer is able to think and work directly in terms of abstractions, and is freed from the process of translating those abstractions into a code that describes them. Second, and equally important, the programming environment becomes fully aware of the fine-grain structure of the program. This creates tremendous opportunities for providing timely feedback and enforcing program consistency. Further, it enables dynamic modification of running programs.

In text-based programming, programmers work with files of characters. In contrast, abstraction-based programming provides a full complement of domain-specific entities that programmers can manipulate to construct functionality of the application. By analogy, it is the difference between an architect creating a blueprint in a paint program, where the units of discourse are lines and pixels, versus creating the same blueprint in a computer-aided design tool, in which the units of discourse are domain-specific entities like walls, windows and doors. Table 1 compares text-based and abstraction-based programming in terms of human-computer interface design principles.

TABLE 1
A comparison of text-based and abstraction-based programming.

| | Text-based | |
|---|---|---|
| Principle | programming | Abstraction-based programming |
| Domain- | Source code files | Variables, parameters, methods, |
| specific | | method calls, statements and |
| objects | | expressions, exception handlers, |
| | | . . . |
| Natural | Cut/copy/paste | Declare variable, override method, |
| operations | text strings | . . . |
| Immediate | Limited (syntax | Type checking, flagging |
| feedback | colorizing, . . .) | incomplete expressions, live |
| | | execution |
| Constrained | Essentially any | Prevention of syntax errors by |
| editing and | text can be | default, consistent variable |
| consistency | typed (compiler | renaming, enforced matching of |
| checking | checks later) | formal and actual parameter lists, |
| | | enforced access protection, . . . |
| Gradual | Significant | No knowledge of syntax is |
| learning curve | syntax and some | required to start. |
| (prerequisites | semantic | Semantics is built up |
| to starting) | knowledge | incrementally. |
| | is required. | |

Table 2 provides a sampling of domain-specific entities and associated natural operations that could be provided by a tool supporting a typical object-oriented programming model. Elevating the unit of discourse is not necessarily directed to inventing new abstractions, but to allowing programmers to work more directly with them. The abstractions are not tied to a particular textual syntax, and so are amenable to a variety of representations.

TABLE 2
Examples of natural operations for entities in the programming domain.

| Domain- | Examples of |
|---|---|
| specific Entities | Natural Operations |
| Classes | New class, extend class, implement |
| | interface |
| Instances | New instance, select instance for viewing |
| Methods | Override, call, make private, add/remove |
| | parameter, add/remove statement |
| Constructors | Call, call parent constructor, add/ |
| | remove parameter, add/remove statement |
| Variables | Declare, initialize, rename, change scope, |
| | make public |
| Parameters | Declare, rename, reorder, delete |
| Statements, expressions | Syntax- & type-controlled editing |
| GUI components | Connect properties, resize, change layout |
| Event handlers | Select source, record event, add/remove |
| | statement |
| Behaviors | Set rate, set termination condition, start, |
| (periodic threads) | add/remove statement |

In one aspect of the present invention, a computer program includes a textual programming language and a language front-end supporting software development in a programming methodology of the textual language, the program providing a graphical programming environment permitting access to types of the textual programming language and permitting subtypes to be defined and modified dynamically (“dynamic types”) while the software under development is executing. The textual programming language could be, but is not limited to, an object-oriented programming language. The object-oriented programming language could be, but is not limited to, Java.

In another aspect of the present invention, a computer program includes an object-oriented programming language and a language front-end supporting software development in a programming methodology of the object-oriented programming language, the program providing a graphical programming environment permitting access to classes of the object-oriented programming language and permitting subclasses to be defined and modified dynamically (“dynamic classes”) while the software under development is executing. Modifications to the dynamic classes can be reflected in future instances of the dynamic classes and in instances of the dynamic classes existing prior to the changes. Java is one possible object-oriented programming language. Further, the dynamic classes can coexist with compiled classes of the object-oriented programming language, the dynamic and the compiled classes each being capable of calling methods on instances of any class, whether that class is dynamic or compiled. The dynamic classes may also be created as subclasses of other dynamic classes or of compiled classes of the object-oriented programming language (“parent classes”) and may selectively override methods of the respective parent classes.

In another aspect of the invention, the present invention provides a computer system including a central processing unit, a memory having a software program development system, where modifications to a program under development take effect immediately while the program is executing, and a graphical user interface supporting direct manipulation of semantic units of the program. In this aspect, changes to classes in the program under development are reflected in future instances of the classes and in instances of the classes existing prior to the changes.

In another aspect of the invention, a method of providing live software construction is presented, the method including providing a graphical editor supporting direct manipulation of semantic units of a program under construction, receiving a programmer definition of or modification to a subclass of a compiled class of an object-oriented programming language, and executing the definition of or modification to the subclass of the compiled class in the object-oriented programming language while the program under construction is executing. Modifications to subclasses in the program under construction can be reflected in future instances of the subclasses and in instances of the subclasses existing prior to the modifications. Subclasses could coexist with the compiled classes, the subclasses and the compiled classes each being capable of calling methods on instances of either of the subclasses or the compiled classes. Subclasses may also be created within other subclasses or of compiled classes of the object-oriented programming language (“parent classes”) and may selectively override methods of the respective parent classes. Upon creation of each subclass a respective peer class may be automatically generated and compiled in the object-oriented programming language.

Contrasting the “dynamic class” of the present invention is a “dynamic class loader,” which is a well-known mechanism used by Java and other programming languages, where classes are loaded into memory dynamically, as they become needed by a running program (as opposed to a “static” class loader that brings all the classes into memory at the beginning of program execution). In the same vein, there are systems that permit the reloading of a class dynamically . . . that is, to let the class loader bring in a compiled class again (possibly with a new implementation), so that future instances of the class could be created with the replacement code. The typical need for reloading would be to correct an error in a running installation. However, in such systems, existing instances of the class either have to continue with the old code, or be destroyed and replaced with instances of the new class, but potential implementation differences (how the data is represented in the old and new class, the set of available methods, etc.) would prohibit old instances from simply adopting the new implementation. This is in contrast to the notion of a “dynamic class” in the present invention, where a programmer can develop an application while it is running by making changes to the implementation (variables, constructors, methods, behaviors, etc.) dynamically over time, with changes affecting not only new instances of the class, but existing instances as well. Such reloaded classes are sometimes referred to as “dynamic classes” because they are reloaded dynamically at points during execution. However, they are distinct from our dynamic classes which may be modified by the programmer during execution without the need to recompile or reload any classes.

### BRIEF DESCRIPTION OF THE DRAWINGS

For the purpose of illustrating the invention, there is shown in the drawing one embodiment of the present invention; it being understood, however, that this invention is not limited to the precise arrangements and instrumentalities shown.

FIG. 1 illustrates a class window for a dynamic class, where each class has a separate window, the class window of FIG. 1, named ‘ShapePanel’, extending Java's “JPanel’ class in accordance with one embodiment of the present invention;

FIG. 2 illustrates an implementation task of an exemplary embodiment of the present invention, the FIG. 2 task creating a FlashingButton class and overriding the setBackground method;

FIG. 3 illustrates an implementation task of an exemplary embodiment of the present invention, the FIG. 3 task creating a ComputeGCD class and its instance variables;

FIG. 4 illustrates an implementation task of an exemplary embodiment of the present invention, the FIG. 4 task creating a view and its connections to instance variables;

FIG. 5 illustrates an implementation task of an exemplary embodiment of the present invention, the FIG. 5 task instantiating the ComputeGCD and defining the FlashingButton's flash behavior;

FIG. 6 illustrates an implementation task of an exemplary embodiment of the present invention, the FIG. 6 task implementing the GCD method using Euclid's algorithm; and

FIG. 7 illustrates an implementation task of an exemplary embodiment of the present invention, the FIG. 7 task defining a controller to handle a user's button press events.

### DETAILED DESCRIPTION OF ILLUSTRATIVE EMBODIMENTS

The present invention is directed to the design and implementation of a new programming environment referred to as a Tightly Integrated Development Environment (TIDE). Such programming environments support the creation of software within an existing high-level language by providing a very close coupling between: (1) a graphical editor supporting direct manipulation of a program's semantic units; and, (2) an execution environment in which program modifications take effect immediately on the running program. TIDE takes advantage of their fine-grain awareness of program structure to constrain program editing, check and maintain consistency, provide timely feedback, and eliminate the edit-compile-execute cycle. Together, these improvements streamline the software development process, with the potential to elevate programmer productivity and enhance the quality of computer science education. TIDEs offer visual representations of semantic units, but unlike visual languages, TIDEs are not new programming languages. Instead, they rest upon an underlying textual programming language, and therefore benefit from years of accumulated research and experience in programming language design. In all of its aspects, the present invention is applicable to any textual language, although an object-oriented programming language, and particularly Java, is detailed in the exemplary embodiment below.

Direct Manipulation of Program Abstractions

One important part of the system design is the systematic creation of graphical representations for common programming abstractions that could be directly manipulated. The methodology is similar to designing a textual language constructs, but with a twist: since the representations are designed for direct manipulation, they are designed not only for expressive power, readability and extensibility, but also for visual intuitiveness, consistency, ease of manipulation, and screen-space utilization. Also, the system can control attributes for unobtrusive timely feedback.

Dynamic Modification of Running Programs

In one aspect of the present invention, a dynamic class, whose members (variables, methods, and constructors) can be defined and changed at run-time. Internally, each dynamic class has mutable data structures representing its members. For example, a dynamic method's data representation includes a parameter list, local fields, body statements, etc. Programmer actions cause changes to these data structures. System design enables full dynamic modification of classes with existing instances. For example, new variables can be added to existing instances. Requiring careful management of the execution environment, the present invention provides each instance of a dynamic class with a dynamic binding table mapping instance variables to values. Initialization occurs on demand—when a dynamic instance first accesses a (new) variable, its initial value is computed, allowing representation invariants to be preserved. This results in a slight but necessary departure from the typical initialization on instantiation strategy to provide the illusion that the variable was “always there,” even if the variable was added later.

As another example, consider dynamic modification of method bodies. Suppose a thread is paused at a breakpoint within an expression. Where should execution resume if the programmer replaces the entire statement containing that expression? Similarly, where should the execution resume if the programmer replaces a logically incorrect statement because it caused a run-time exception? One could abort the threads and require the programmer to start over, but that would severely limit live incremental software development. In the former case, the present invention preempts execution of the deleted expression and resumes execution with its replacement. In the latter, the programmer can use a debugger's single-step function to propagate the exception as far out as desired and retry execution with the new statement in place.

Problems like these would never come up once the program under development is completed and deployed, for presumably the program would not be getting modified in the field. However, consistent handling of modifications during execution is critical to providing reasonable execution semantics during the development process.

Interoperability of Compiled and Dynamic Classes

Besides encapsulation, a main advantage of object-oriented software development is support for inheritance and polymorphism. Therefore, it was incumbent upon a design of this environment to allow methods to be overridden by dynamic classes. More specifically, the present invention provides capability to override a method in a dynamic class at run-time. Further, instances of compiled classes can hold references to instances of dynamic classes and treat them as instances of compiled classes. For example, suppose X is an instance of dynamic class named ‘Child’, which is a subclass of compiled class named ‘Parent.’ Further, suppose that some instance Y of an arbitrary compiled class has a reference to the instance of Child, and that this reference is held (polymorphically) in a variable of type Parent. Now, if Child overrides a method defined in Parent and then Y calls the method polymorphically on X, we want the method declared within dynamic class Child to run, even though Parent's method would have run only moments before. Furthermore, if the programmer subsequently deletes the overriding method in Child, we want future calls to revert to the inherited method defined in the compiled Parent class.

The present invention achieves complete interoperability between compiled and dynamic classes, with a minimum of overhead during execution. As a starting point for one exemplary embodiment, Java is chosen as the underlying language partly because its reflection package provides access to a great deal of type information at run time. In particular, Java provides a class named ‘Class’ whose instances embody information about each class that is loaded into the Java Virtual Machine. It provides run-time access to the fields, methods, and constructors of a class. While its byte code is interpreted, Java does not permit run-time modification to classes. For example, a running application can request a list of methods of a class, and even use reflection to invoke them, but Java does not provide methods that permit a running application to add a new method to a class or change the body of an existing method, nor does it allow a subclass of ‘Class’ be created in order to provide such support. To create classes that can be dynamically modified in Java at run-time, without modification of the language or the virtual machine, a hybrid execution environment was developed and is used, where instances of dynamic and compiled classes have parallel reflection hierarchies, one dynamically modifiable and the other not, with wrapper classes in the class hierarchy that allow compiled and dynamic classes to be treated uniformly. Instances of dynamic classes present themselves as instances of compiled classes, with callbacks into peer dynamic instances with dynamically modifiable methods. Execution of dynamic classes is accomplished by traversing the internal data structures representing the program. Calls to compiled methods are handled with reflection. Caching of method references is used extensively to streamline execution and avoid repeated searches for overridden methods.

Functional Overview of the Present Invention

In this embodiment of the invention, where Java is the underlying textual language, a tightly integrated development environment (TIDE) is described, called JPie (Java Programmer's Interactive Environment), which supports live interactive object-oriented software development in Java.

JPie's principal visual unit is the capsule. Capsules represent variable declarations, variable accesses, properties, methods, method calls, constructors, constructor calls, and can also contain constants and expressions. Every capsule has a label (typically used to display a textual identifier), an icon (to indicate the type of the value the capsule contains or produces), and a color (to indicate its scope of declaration). Providing all of this information as a glance saves the programmer from having to remember, for example, the parameter types and return type of a method, or whether a variable is local or an instance variable. Capsules are used by direct manipulation (selection or drag-and-drop), not indirectly by name, so the labels on capsules have no semantic significance in the execution and serve only as documentation. The system maintains consistency of identifiers. If a variable or method is renamed, the labels at each use are updated accordingly.

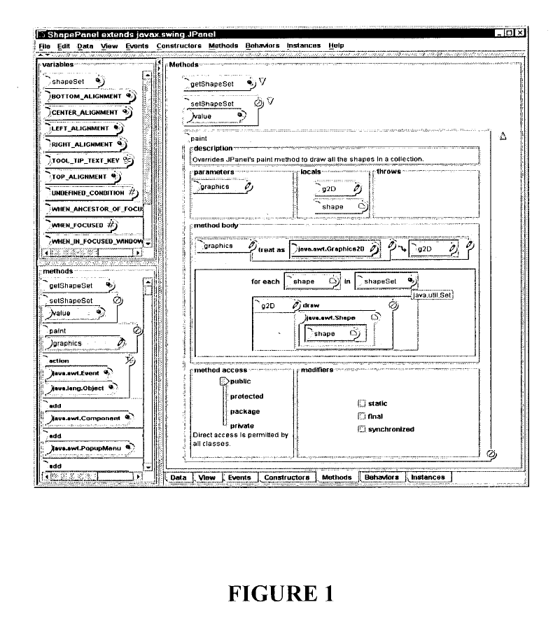

Programmers manipulate capsules and other objects within clearly identified semantic regions. For example, FIG. 1 illustrates a ‘Methods’ region, which in turn contains regions for the ‘parameters’ and ‘method body’ in a method. Semantic regions serve two purposes. First, they organize the program into structural units. This contributes to user interface consistency, efficient navigation and screen space utilization, and helps the programmer focus on the current task by controlling what information is displayed. Second, semantic regions serve as consistent and intuitive targets for direct manipulation operations, such as statement creation, expression building, and drag-and-drop operations. For drag-and-drop, the semantics depends on what capsule is dragged, and into which semantic region it is dropped.

When the system starts, the programmer is provided with a ‘Packages and Classes’ window containing: (1) a tree representation of all the packages and classes in the Java API, as well as the programmer's own classes; and (2) a place for the programmer to create short cut panels in which to organize frequently used classes into categories. From this window, one can open classes for editing and create new classes that extend other classes or implement interfaces.

Each class has a separate window (such as that shown in FIG. 1). Tabs along the bottom of the window provide access to panels that serve as top-level semantic regions for Data (instance variables), View (graphical appearance, layout, and property connections), Event handlers (listeners to the view components), Constructors, Methods (shown), Behaviors (periodic tasks that run as separate threads), and Instances (a list of instances of the class, selectable for viewing). In addition to these semantic regions, the window provides convenient summary lists of the variables and methods of the class (with inherited members shown in a different color). Multiple windows for the same class may be open simultaneously.

Programmer actions are understood by the system on the basis of the semantic region in which they occur. This allows declarations and other editing operations to be completed in one atomic gesture. For example, when a programmer drags a type capsule from the ‘Packages and Classes’ window into the Data panel, the system declares an instance variable of that type (and automatically defines associated ‘get’ and ‘set’ methods). On the other hand, if the programmer drags that same type into the Methods panel, the system declares a method with that return type. Similarly, dragging an inherited method into the Methods panel creates a method to override the inherited one.

Some capsules, such as methods and constructors, can be expanded to expose additional semantic regions. For example, inside methods there are clearly labeled semantic regions in which to declare formal parameters, to declare local variables, to create statements within the method's body, and to specify a return expression (if the return type is not void). Again, simple gestures are used to make atomic changes to the program. For example, drag-and-drop gestures can be used to declare a variable (with its type and scope), access a variable or call a method within the body, reorder the formal parameter list, or move a local variable into the parameter list. Clicking within a method body creates a new statement at that point. Note that when the parameter list is modified, the system automatically updates method calls.

Statements and expressions are formed as chains of capsules. The icon at the right of a capsule, which indicates type of the expression at that point in the chain, provides opportunities to extend the chain (by accessing variables, calling methods, etc.), similar to the dot (‘.’) notation in textual programming. Nested boxes provide an explicit visual representation of scope and the order of execution. All execution, including assignment, occurs left to right, respecting the indicated nesting. This avoids any possible confusion about order of operations, and provides a convenient way to move statements among scopes. In addition, the capsules for method calls and constructor calls have semantic regions called slots, in which actual parameters are specified. In addition to chain expansion, the system provides a calculator-like interface for building statements involving control constructs and expressions involving mathematical operators.

The user interface prevents the formation of syntactically incorrect statements and expressions. For example, a variable can only be dropped into a scope having access to that variable. Similarly, when a chain is extended with a method call, only the accessible methods for that type are presented as options. However, when an expression of a particular type is required, temporary type mismatches may necessarily occur along the way to forming the expression. For example, if an integer is required as the parameter type and one drops a ‘list’ variable into the slot, there would be a type mismatch, but completing the expression by calling the ‘size’ method on the ‘list’ variable would fix the problem. Whenever an inconsistency occurs, the system provides immediate feedback. For example, each slot in a method call knows its expected type and will display a red border whenever its contained expression's type is not compatible. Incomplete expressions are similarly highlighted. References to subsequently deleted (or inaccessible) variables and methods are grayed out. In all cases, placing the cursor over the offending expression reveals pop-up text that explains the problem.

FIG. 1 shows the class window for a dynamic class named ‘ShapePanel’ that extends Java's ‘JPanel’ class. This example illustrates the visual representation of variables, methods, formal parameters, method calls, actual parameters, casting (in this example, casting is used to treat a variable of type “Graphics” as an expression of type “Graphics2D”), assignment, and modifiers. Overriding the paint method in this subclass of ‘JPanel’ was accomplished by dragging the inherited method (from the summary list at left) into the methods panel. Upon declaration, the method took immediate effect, even for objects that were already instantiated and whose paint method is called polymorphically by compiled classes. In the paint method, the “for each” construct was used to simplify iteration over the collection, but the programmer instead could have used an iterator in conjunction with a while loop.

Programmers can create threads in the conventional way, by creating a subclass of the ‘Thread’ class and calling its start method. In addition, we provide a Behaviors panel to streamline the creation of threads that carry our periodic tasks within objects of the class. For example, instances of an ‘animation’ class might have a behavior to periodically change the image in the animation. Each behavior looks like a method with a void return type, but has additional regions in which to specify a rate expression and a termination condition. Behaviors can be started automatically on instantiation.

Together, the View and Events panels support user interface construction. Within the Views panel, one can drop graphical components onto a panel and manipulate their sizes and positions. (In addition, there are automatic layout options.) This specifies what each instance of the class should look like to the user. Selecting a component allows the programmer to see the properties of that component. Those properties can then be connected to the properties of the class (i.e., instance variables) or to properties of other components in the view by chaining their capsules together. In addition, the initial values of component properties can be specified within expanded views of the property capsules.

In the Events panel, components of a view can be selected to create event handlers that process user input. Each event handler is a listener method in the Java event model. The programmer demonstrates the user event of interest (mouse click, mouse entered, etc.) by performing the event on the selected component, and then selecting the event from a list of all the recorded events. At that point, the event handler method turns into the appropriate listener method with the appropriate parameter for that event type. The programmer can edit the body of the event handler just as for any other method of the class. The listener is automatically added to the component by the system so that whenever the event occurs in a view of any instance of the class, it triggers execution of the event handler within that instance.

JPie provides a thread-oriented debugger that uses the same visual representation that is used in the class windows. Programmers can set breakpoints on methods, constructors, behaviors, event handlers, statements, and expressions. When a breakpoint is reached within execution of a thread, a debugger window pops up, showing the call stack as a series of tabbed panes. Each pane shows the expanded visual representation of the method (or other item) responsible for that stack frame. The debugger highlights (within the each stack frame) the expression that is currently executing (or about to execute in the case of the top stack frame). In the debugger, the programmer can control the execution speed of that thread and watch the execution unfold, or can single-step through the execution expression by expression, with pop-up text displaying values for executed expressions. In addition to breakpoints, any consistency errors (such as type mismatches) cause the debugger to appear when execution of the offending expression is attempted. The programmer then has the opportunity to complete or correct the expression and resume execution. Similarly, the debugger supports on-the-fly exception handling; when an exception occurs that is not explicitly caught or thrown by a method, the debugger appears and provides the programmer with the opportunity to catch (or throw) the exception and resume execution. The debugger also provides proactive support for detecting common logic errors before they become fatal errors. This includes dynamically adjustable stack bounding to detect infinite recursion, dynamically adjustable loop bounding to detect infinite loops, and deadlock detection. In the case of deadlock, a separate window appears with a visualization of the cycle in the wait-for graph. Within that visualization, the programmer can click on threads involved in the cycle in order to bring up debugging windows for them, and optionally terminate them to break the deadlock.

An Exemplary Embodiment of the Present Invention

In an exemplary embodiment, the present invention presents a language front-end for the Java programming language, as well as run-time middleware that supports live interactive software construction, including interoperability between compiled classes and dynamically modified classes. Java is selected in the exemplary embodiment because it is a modern object-oriented language with a garbage-collected heap and strict type checking, but also because it offers significant opportunities for run-time queries of type information through its built-in reflection package.

This embodiment illustrates the design philosophy of the present invention through construction of one exemplary embodiment. However, the following description of the exemplary embodiment in no way limits, nor is intended to limit, the embodiments possible with the invention, but rather illustrating how certain aspects of the present invention can be reduced to practice.

The figures accompanying the following description make the present invention appear deceptively simple, for one goal of the present invention is to make software construction natural and intuitive. The importance of the described embodiment is not in the mechanics itself, but in how the mechanics are realized in a manner consistent with the design objectives. The reader is asked not to approach the example as an excerpt from a programming manual, but rather as vehicle for explanation of a philosophy. Careful consideration of both the text and figures of the example is necessary to appreciate the subtleties, as well as the breadth, of the present invention.

Specification of the Exemplary Embodiment

In the exemplary embodiment, a user enters two integers into text fields and then presses a flashing button to see greatest common divisor (GCD) of the two integers appear as text of the button. It is understood that this example is not overwhelmingly practical in its own right, but is chosen here to illustrate the following features of the invention in a relatively small space: extending classes, overriding methods, defining object behaviors, declaring and using variables, defining and calling methods with parameters, creating a graphical view for an object, relating the view to the object state, defining a recursive method, and specifying and handling user events. Accordingly, this example would be an appropriate exercise in an introductory programming course.

Implementation of the Exemplary Embodiment

A programmer might implement the above specification in our programming environment by performing the following tasks. Because the development is live, program modifications affect existing instances, providing additional flexibility on the ordering of the steps in the implementation. Therefore, the particular sequence is not regimented. Other implementations, including alternative orderings of these steps, are possible.

1. Define a new type of button, namely a flashing button, as a subclass of an existing button class.

2. Define a ComputeGCD class with instance variables to hold the user's input and the textual output.

3. Define a view for the class containing data entry fields and the button for triggering the computation.

4. Create an instance of the ComputeGCD class to use for testing.

5. Define the method that will compute the GCD.

6. Specify the action that should occur when the user presses the button (namely, that the GCD method will be called and the result will be used as the textual output).

The following details how a programmer could carry out implementation within the programming environment of the present invention. At each step is highlighted certain design objectives with illustration of one, but by no means the only one, possible approach to implementation.

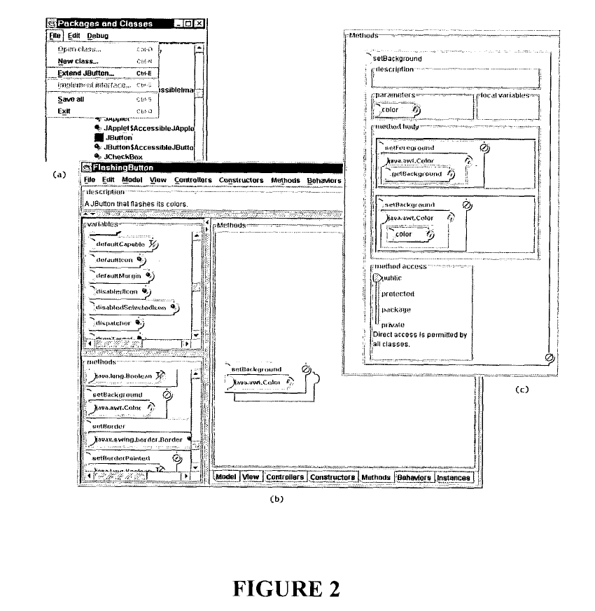

Note that screen displays present during use of the invention are in color, some of the displays being illustrated by the figures herein. The figures, however, are in black and white, thereby resulting in some information loss. Most of the figures included herein show a sequence of screen shots taken at various steps in the software construction. For example, FIGS. 2a, 2b, and 2c are causally related snapshots taken at different times. They would not appear on the screen simultaneously, but have been assembled in a single figure to show a sequence of sub-steps for Step 1. Throughout the description, the word programmer refers to an individual using our programming environment to build an application, whereas the word user refers to someone who would use that application. The following numbered paragraphs refer, respectively, to the six (6) step implementation outline above:

1. Create the Flashing Button Class: In this step, we create a dynamic subclass of a compiled class and override one of its methods. The language front-end transparently exposes all of Java classes and interfaces, along with the programmer's own compiled and dynamic classes, in the “packages and classes” tree. In FIG. 2a, we select Java's JButton class and choose “extend JButton” from the file menu. The system automatically creates a dynamic subclass of JButton, which we name FlashingButton. Although dynamically modifiable, the new class is a true subclass of JButton and inherits its variables and methods. To avoid textual identifiers, all variables and methods (including inherited ones) are represented as capsules. For semantic visibility, each capsule's (return) type is shown as an icon and its scope is indicated by its color. Therefore, programmers do not have to remember the type or scope of variables used in expressions. Declared methods, inherited methods, and overridden methods are also distinguished with different colors. To override the method setBackground, we drag its capsule into the methods panel, as shown in FIG. 2b. The overriding method appears automatically in the methods panel with its name and parameter. Then, in FIG. 2c, we define the method body so that whenever the background color is set, the old background color is used as the new foreground color. This new method will be used later in order to create the flashing behavior for the button. It fully interoperates with compiled code, and may be called polymorphically. Note that the programmer edits the method body using mechanisms that expose the semantics of the underlying language (objects, instance variables, formal and actual parameters, method calls, etc.). The programmer can only call existing methods and never sees a syntax error message, since editing is done using selection and direct manipulation within an interface that provides no opportunity for syntax errors. Furthermore, type checking is handled interactively. For example, actual parameter expressions are edited within “slots” corresponding to method's formal parameters, ensuring syntactic consistency of method calls and providing immediate feedback when the type of the expression is not assignable to the type of the slot.

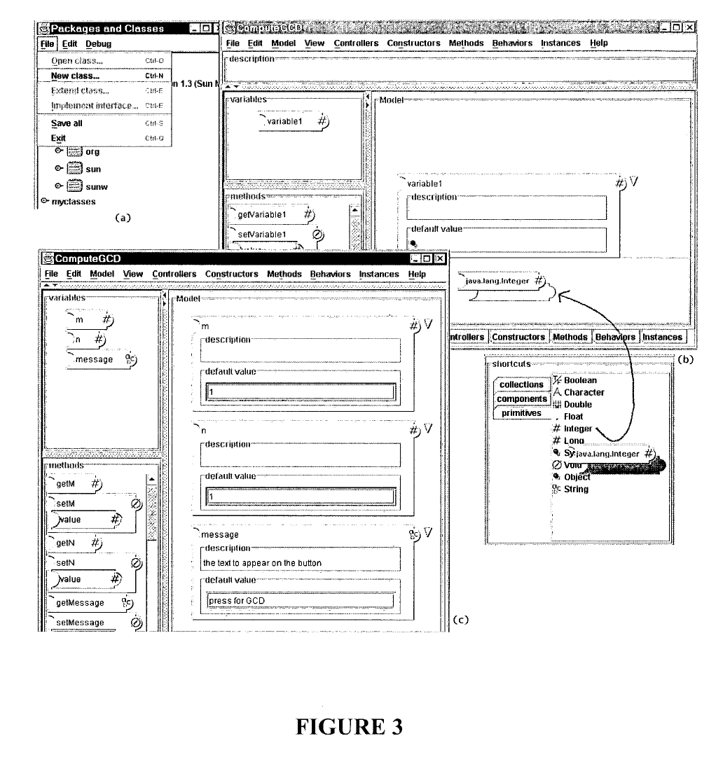

2. Create the Application's Main Class and Its Instance Variables: This step defines a dynamic class called ComputeGCD with three instance variables: integers n and m, and a text variable whose value will appear on the button. Since we are not extending a class, we choose “New class” (FIG. 3a) and the system creates a dynamic class that extends Object by default. In the underlying textual language, we would use text to declare variable types and textual identifiers would be repeated at each use. However, in our language front-end, variable declaration and use are accomplished by direct manipulation. To declare a variable, we drag the desired type to a declaration panel. To use a variable, we either select it from a list or drag it to the intended expression. FIG. 3b shows the Integer type being dragged from the from the shortcuts panel to declare the second instance variable of the ComputeGCD class. (Types may be dragged either from the packages and classes tree or from the shortcuts panel. The shortcuts panel is a convenient way for programmers to keep frequently used classes organized by category.) To encourage good programming practice, the system creates instance variables as private and automatically creates public accessors for each, but the programmer is free to change the access modifiers and/or delete the automatically created methods. Since variable names are used only for documentation, they may be changed freely, and the system updates all uses automatically to provide consistency with the underlying textual language. In FIG. 3c, we have given names to the instance variables, and the names of the accessor methods (getM, setM, etc.) have been updated automatically.

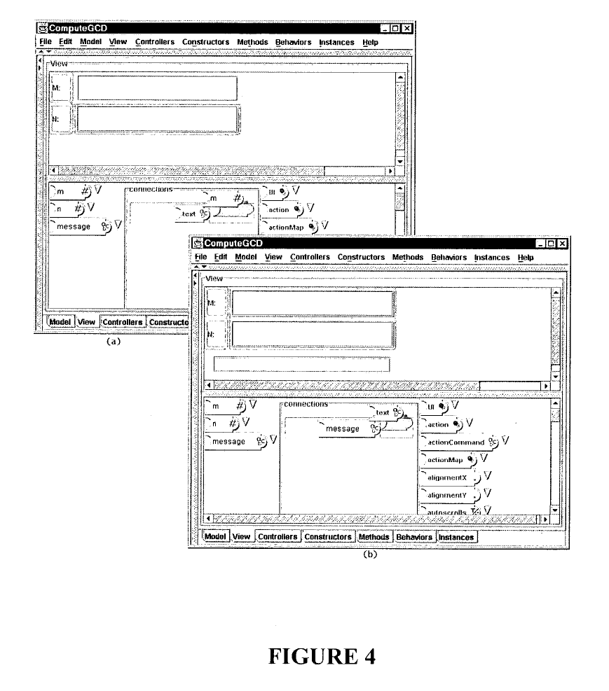

3. Define a View for the Application and Relate it to the Instance Variables: This step highlights the interoperability between compiled classes and dynamic classes. We specify the application's view interactively, as in most modern GUI builders, by choosing and arranging the graphical components, but here the components are instances of both compiled and dynamic classes. Furthermore, we can define relationships not only among the properties of the graphical components, but also between those properties and the data model in the dynamic class. (As is standard practice, the view and the model are kept separate, so we can create more than one view of each instance of the class. Therefore, each view has a corresponding instance, but each instance may have multiple views.) First, we drag the JTextField capsule from the shortcut panel into the view panel, which responds by creating an instance of JTextField and adding it to the view. We do this twice, to create fields for the user to enter the values m and n. Then, we add labels by the text fields, and adjust the layout by direct manipulation. To establish a connection from the text property of the first text field to the variable m, we drag both the text property and the instance variable m into the connection panel (see FIG. 4a). As a result of this connection, the user can set the variable m of an instance of the class by typing into the corresponding text field in its view. We make a similar connection from the other text field to instance variable n. To put the flashing button in the view, we drag the capsule for our FlashingButton class into the view panel. Even though it is a dynamic class, FlashingButton extends JButton so its instances can be added to the graphics container, which treats them just as instances of a compiled component. These instances interoperate fully with the compiled code. For example, if the compiled code for the graphics container calls the setBackground method polymorphically on a FlashingButton, the statements of our overriding method will be executed, even though the container knows nothing about dynamic classes. In FIG. 4b, the programmer establishes a connection so the text in the message instance variable will be displayed on the FlashingButton.

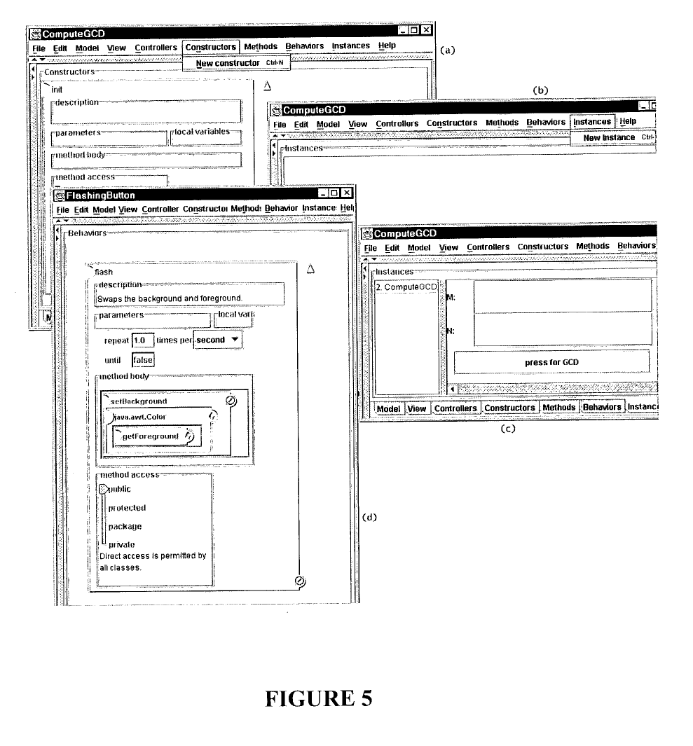

4. Create an Instance of the Class, and Define the Flashing Behavior of the Button: In this step, we see how modifications of a dynamic class are reflected immediately, even in instances that have already been created. First, we create a constructor for the ComputeGCD class (FIG. 5a). We could add parameters and statements to the constructor, but none are needed. Next, in FIG. 5b, we create an instance of the class simply by selecting “new instance” from the menu. Then, in FIG. 5c, we are presented with a selectable list of instances, and select the (only) instance to see a view corresponding to that instance. The text message “press for GCD” is displayed on the button according to the connection that we defined in Step 3. However, upon realization that the button isn't flashing, we must return to the FlashingButton class and add a new behavior to that class. Behaviors are convenient mechanism that we provide for creating threads that perform a task periodically. Programmers could, within our environment, achieve the same periodic effect by creating a dynamic class that extends the Thread class, and override the run method with a loop that performs the desired computation, calling sleep as needed. However, that approach is considerably more work, so we provide the behavior mechanism to streamline the common case. As shown in FIG. 5d, the flash behavior calls the setBackground method once per second, passing the button's current foreground color as the parameter value. As before, actual parameter expressions are put into slots corresponding to the types of the formal parameters, so programmers needn't remember the number and order of parameters. Recall that the setBackground method was overridden to copy the old background color to the foreground, so this behavior will have the effect of swapping the foreground and background colors once each second. As a result of this new behavior, all instances of the FlashingButton class begin flashing immediately, without any compilation.

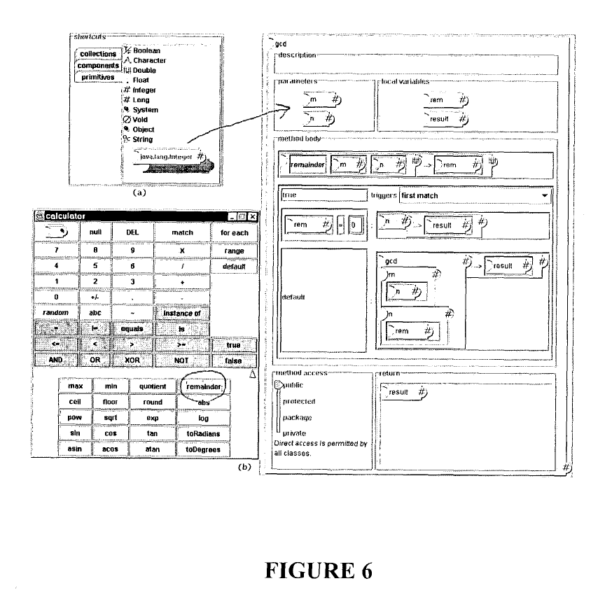

5. Define the GCD Method: The task of computing the greatest common divisor of m and n will be performed by a recursive method that implements Euclid's algorithm. This step provides an opportunity to discuss the mapping between the language front-end and the underlying textual language. Although one of our stated goals is semantic transparency, we are not attempting to achieve syntactic transparency. It may seem that the best approach would be for the front-end to mimic the syntax of the underlying language. However, when we move to expressing programs in a direct-manipulation graphical interface, using a syntax specifically designed for text is not natural. However, we must remain close enough to the underlying language so that we can provide a relatively easy transition for programmers who wish to move into the underlying language later. Our syntax is not identical to that of the underlying language, but has a fairly straightforward mapping to it. All statements are constructed by direct manipulation, selection and form filling, thereby eliminating syntax errors. The type and scope of every variable and expression are evident visually. Type mismatches are immediately flagged with color and explained by popup text. Formal parameters and local variables are declared in separate panels and shown in different colors. Because variable use is by direct manipulation (dragging and dropping), variable name masking is not an issue, so no syntax is required to disambiguate. Nesting is represented by nested boxes, rather than by parentheses and curly braces. We avoid “precedence rules” since the order of execution is made explicit by the nested boxes. Chained capsules represent assignment and method calls, and all statements, including assignment, are evaluated left to right, respecting nesting. To create the first statement in the GCD method (FIG. 6), we use the remainder button on the “calculator” to create an expression with two blanks, into which we drop the two parameters. We then assign the expression's value to the local variable rem. To choose between the base case and the recursive call, we use a guarded command “match” construct that subsumes the “if,” “if-then-else,” and “switch” statements of the underlying language. The “match” statement has a target expression (in this case, the boolean value true) that is compared for equality with the left side of each guarded command. The programmer has two options: “first match” causes only the consequent of the first matching guard to be executed, whereas “every match” causes the consequent of every matching guard to be executed. The “default” guard is similar to “else.” Here, “first match” is chosen, so if the remainder is zero, the value of n is used as the result. Otherwise, the result is computed by a recursive call, passing parameters n and rem. Again, note that existing instances are updated immediately without recompilation.

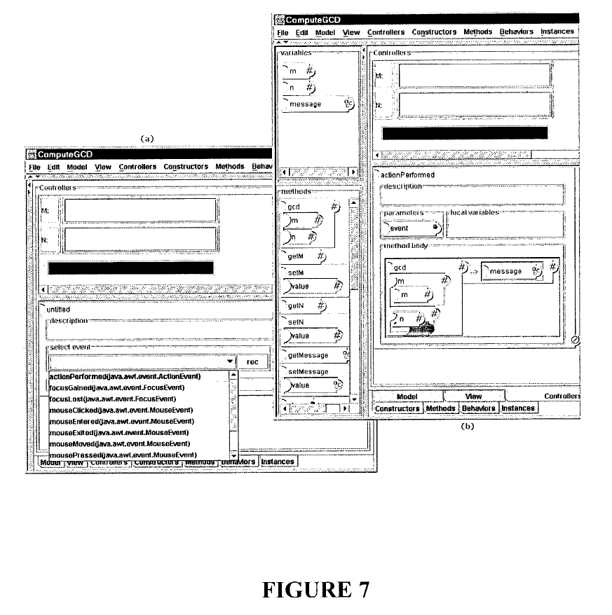

6. Handle the User's Button Press Event: To complete the application, the programmer must specify what should happen when the user presses the flashing button, namely that the GCD of m and n be computed and that the result be displayed on the button. Handling user events is a very common task in applications development. In raw Java, this would be handled by writing a class that implements the ActionListener interface, defining an actionPerformed method to carry out the desired computation, instantiating the listener, and registering the listener with the button. In a typical GUI builder, the user might select from a list of possible events and much of the necessary code would be automatically generated. The programmer would then edit the actionperformed method in the textual language to achieve the desired computation. In either case, the code would need to be compiled and, depending on the situation, execution of the entire program would have to be restarted. In our programming environment, we decided that event handling was sufficiently common that special support should be provided. Therefore, we have created a special kind of method, called a controller, which can be attached to any component in a view in order to handle events generated by that component. In the example, the programmer selects the FlashingButton in the view and then chooses “new controller” from the menu to create an untitled controller method. The system will automatically create a listener and register it with the component, but first the programmer must choose the appropriate event type. Again specialized support is provided, so the programmer can demonstrate the event and then choose it from the events that have occurred at that component. In FIG. 7a, the programmer presses the “rec” button in the controller method to begin recording user events on the button. The programmer then demonstrates the desired user event by clicking on the FlashingButton in the view. At this point, all the user events that have been recorded appear in the drop-down menu. The programmer selects “actionPerformed.” As shown in FIG. 7b, the system immediately renames the method actionPerformed, creates the required formal parameter, creates the appropriate listener, and registers the listener with the button in every view of each ComputeGCD instance. Now, whenever the user presses the FlashingButton, the actionPerformed method will be called. The programmer completes the actionPerformed method to call the GCD method (passing in the values in the instance variables) and assigns the result to the message variable that is mapped to the button's text property. During development and testing, programmers require an integrated debugger to observe the step-by-step execution of each thread. Unlike standard textual debuggers, our approach provides fine-grain debugging, one expression at a time, rather than one line at a time, and we provide that all changes to the program during debugging to take effect immediately. Our debugger, illustrated in FIG. 8, supports examination of the call stack, setting breakpoints, and stepping through the execution.

Design and Implementation of Run-Time Middleware

As discussed, Java was chosen as the underlying language in the exemplary embodiment because its reflection package provides access to a great deal of type information at run time. In particular, Java provides a class named ‘Class’ whose instances embody information about each class that is loaded into the Java Virtual Machine. It provides run-time access to the fields, methods, and constructors of a class. However, although its byte code is interpreted, Java does not support run-time modification to classes. For example, a running application can request a list of methods of a class, and even use reflection to invoke them, but the class ‘Class’ is immutable. In other words, Java does not provide methods that permit a running application to add a new method to a class or change the implementation of an existing method. To further compound the problem, the class ‘Class,’ along with its related classes, is declared as ‘final,’ thereby preventing the creation of subclasses that could provide the desired functionality. To create classes that can be dynamically modified at run-time, in Java, without modification of the language, a piece of middleware is used. The middleware sits between the language front-end and Java's run-time system. The middleware of the present invention provides a hybrid environment in which instances of dynamic and compiled classes smoothly interoperate.

The present invention provides object-oriented software construction permitting classes to be changed dynamically while the software is executing (dynamic classes). Changes to the dynamic classes are reflected not only in future instances of the classes, but also in instances of those classes that existed prior to the changes. In the present invention, a class hierarchy contains classes herein called DynamicClass, DynamicField, DynamicConstructor, and DynamicMethod, each paralleling a functionality of the final and immutable Java classes Class, Field, Constructor, and Method, and additionally allowing properties of instances of these classes to change dynamically during execution. The dynamic classes coexist with compiled classes written in an underlying programming language (e.g., Java in the exemplary embodiment), and in which each type of class (compiled and dynamic) may call methods on instances of either type.

The class hierarchy could further contain classes herein called ClassWrapper, FieldWrapper, ConstructorWrapper, and MethodWrapper, containing references to an instance of the class Class, Field, Constructor, and Method, respectively. Still further, the class hierarchy could contain classes herein called DClass, having subclasses DynamicClass and ClassWrapper; DField, having subclasses DynamicField and FieldWrapper; DConstructor, having subclasses DynamicConstructor and ConstructorWrapper; and DMethod, having subclasses DynamicMethod and MethodWrapper. Here, the classes DClass, DField, DConstructor, and DMethod provide methods that are overridden by their subclasses to support uniform treatment of dynamic and compiled classes through polymorphism.

The present invention provides dynamic classes that may be created as subclasses of compiled classes and selectively override methods of the parent class. Compiled classes may call methods on instances of dynamic classes, resulting in the overridden behavior being exhibited.

Each dynamic class has a peer class automatically generated and compiled when the dynamic class is first created. Java source code for the peer class is generated automatically, compiled into byte code by a standard Java compiler, and then loaded into the Java interpreter at the time the dynamic class is created. The peer class need not be changed after it is generated, even if the dynamic class is modified. The peer class, however, may be changed in order to accommodate a change in the class hierarchy (in which the programmer requests that the dynamic class extend a different class or implement a different set of interfaces). Each instance of the dynamic class (dynamic instance) has a unique corresponding instance of the peer class (peer instance). The dynamic instance uses its peer instance as a proxy to invoke compiled methods and constructors on behalf of the dynamic instance. Each dynamic instance has a reference to its peer instance, and each peer instance has a reference to its dynamic instance. The peer class overrides all methods of the parent class, so that execution of any method overridden by the dynamic class is deferred to the dynamic class, and execution of any method not overridden by the dynamic class is deferred to the super class. In the Java embodiment of the present invention, Java's reflection package is used to discover the signatures of the methods of the parent class (name, parameter types, return type, modifiers, and exceptions thrown) to generate source code for the overriding methods in the peer class. The body of each overriding method invokes the corresponding overriding method in the dynamic class if such a method has been defined, and otherwise invokes the inherited (super) method, returning the result in each case. A default return value is used (or, alternatively, an exception is thrown) in the case that the compiled peer's super method is defined as “abstract” and the dynamic class does not override the method.

The peer instance is used as the target of method calls made by compiled classes. The peer instance or the dynamic instance may used as the target of method calls made by dynamic classes. The peer class is hidden from the programmer, providing the illusion that only the dynamic class exists. Distinction between the dynamic instance and the peer instance is hidden from the programmer, providing the virtual appearance that the object is represented by only a single instance, the dynamic instance. The peer class retains a cache of information about the methods overridden by the dynamic class, so that method calls on instances of the peer class can be optimized. The cache is implemented as an array (or, alternatively, any indexed data structure) and each method defined in the compiled peer has a unique index into the cache. The cache is consulted in determining whether a corresponding method exists in the dynamic class.

Modifications to dynamic classes may include a declaration of dynamically modifiable instance variables (dynamic fields) for retaining information within instances of the dynamic class. Each dynamic class internally maintains a collection of objects representing its instance variables and their properties (name, type, modifiers, etc.), and each instance of the dynamic class maintains a mapping from these objects to their associated values in that instance. The DynamicClass has methods for adding and removing DynamicField objects that, in turn, maintain the information about each dynamic field of the class and provide methods to read and write the value of that field on an instance by instance basis. Methods to get and set the value of the instance variable (accessor methods) are automatically defined when the instance variable is declared.

Modifications to dynamic classes may include a declaration of dynamically modifiable constructors (dynamic constructors), with zero or more parameters, zero or more local variables, and zero or more statements for initializing information stored within instances of the dynamic class. Each dynamic class internally maintains a collection of objects representing information about each constructors, including its parameters, local variables, and statements. The DynamicClass has methods for adding and removing DynamicConstructor objects that, in turn, maintain the information about each dynamic constructor of that class and provide a method for invoking the constructor in order to both create a new instance of the dynamic class and carry out the constructor's steps to initialize that new instance.

Modifications to dynamic classes may include a declaration of dynamically modifiable methods (dynamic methods), with zero or more parameters, zero or more local variables, and zero or more statements for operating upon information stored within instances of the dynamic class, and (optionally) a return statement. Each dynamic class internally maintains a collection of objects representing the information about its methods, including their parameters, local variables, and statements. The DynamicClass has methods for adding and removing DynamicMethod objects that, in turn, maintain the information about each dynamic method of that class and provide a method for invoking the method on an instance of the dynamic class in order to carry out its steps and return statement.

Modifications to dynamic classes may include the construction of a view for graphically displaying information stored within instances of the dynamic class. A layout order and constraints for components of the view are automatically determined on the basis of a rough layout provided by the programmer, with further layout options including, but not limited to: regular grid (for example, to determine dimension and insertion order for Java's GridLayout), aligned (for example, to determine constraints for Java's GridBagLayout), border (for example, to determine the center, north, south, east, and west components for Java's BorderLayout), scaled layout (in which component positions and sizes scale to fit their container), and free form (in which components are arranged exactly as specified by the programmer). Modifications to dynamic classes may include defining relationships, herein called connections, among the components of a view and between those components and the instance variables of the dynamic class. Each dynamic class internally maintains a collection of objects representing information about each component in the view, the relationships among them, and their relationships to the instance variables of the dynamic class. Modifications to dynamic classes may include defining actions, herein called controllers, containing steps that should be carried out in response to events, such as user actions, that may occur within the view. Controllers are a special case of dynamic methods that serve as Java event listeners.

Modifications to dynamic classes may include the definition of actions, herein called behaviors, with zero or more parameters and zero or more local variables, and containing zero or more steps that should be carried out periodically by instances of the dynamic class. A modifiable expression is included to describe a periodicity of the execution, and a modifiable condition, upon which the periodic execution should cease. Behaviors are implemented as Java threads. Furthermore, for behaviors without parameters, the programmer may indicate that the behavior be started automatically (auto start) following initialization of each instance of the class.

Each constructor, method, controller, and behavior in a dynamic class internally maintains collections of objects representing, where applicable, its parameters and their names and types, its local variables and their names and types, the steps of its body, and its return statement. All statements and expressions (such calculations, method calls and assignments) are maintained within the dynamic class as data structures that are traversed on execution. All the values of parameters and local variables are maintained during execution as a mapping from variables to values within each scope.

Design and Implementation of a Visual Representation for Construction, Visualization, and Manipulation of Dynamic Classes

The present invention provides a visual representation allowing programmers to view the modifications to dynamic classes, and in which the textual syntax of the underlying programming language can be hidden. An interactive mechanism, using the visual representation, supports programmers in a process of carrying out the modifications to dynamic classes. In the visual representation, each class, variable, constructor, method, controller, behavior, and parameter is represented as a capsule (or other visual unit) displaying its textual name, with its scope visually indicated as a color (or other visual cue), and its data type or return type visually indicated as an icon (or other graphical representation) with optional popup text indicating the name of the type. Programmers can create and edit the icons used to represent compiled and dynamic classes.

Within the visual representation, statements and return values within a body of each constructor, method, controller, and behavior are displayed as chains of capsules and visually nested expressions. The icon on each capsule provides access to the (return) value of that capsule. Uses of each variable, constructor, method, controller, and behavior may be accomplished by selection from a list or by dragging its, capsule to the expression or chain in which it is to be used. The interactive mechanism further provides that users can extend a chain by selecting the icon of a capsule to reveal a menu of available options, which may include accessing an instance variable, calling a constructor to create a new instance, calling a method of the class or instance, starting a behavior, assigning the value to a variable, or casting the value to be treated as a compatible type. The menu of choices depends upon the data type of the capsule, as indicated by the icon, and the class and scope in which the chain resides. In conjunction with this expression chain representation, users may create expressions and statements using a calculator-like interface. In general, incomplete or type-mismatched expressions are visually indicated and popup text may optionally provide further details such as the specific type expected.

The interactive mechanism provides that the body of each constructor, method, controller, and behavior may be selectively shown or hidden by the user. Further, the name of a variable, constructor, method, controller, and behavior may be updated directly on its capsule, and all capsules representing uses of that variable, constructor, method, controller or behavior will have their textual names automatically updated.

Similarly, changing the name of a variable causes the name of the accessor methods (for getting and setting the value of the variable) to be appropriately updated.

Tightly Integrated Thread-Oriented Debugger

The interactive mechanism provides that users can execute the software programs they have constructed (developed), and users may examine the views corresponding to individual instances of each dynamic class. Further, users may control a speed of execution and receive visual feedback to indicate the currently executing statement or expression within the context of its containing constructor, method, controller, or behavior. Users may observe the values produced by the most recent execution of each expression, may observe an execution stack for nested method calls and constructor calls, and may select any level of the execution stack to observe the currently executing expression within the context of its containing constructor, method, controller, or behavior.

Users may specify points in the program, commonly called breakpoints, where execution will automatically pause for observation purposes. Upon reaching a breakpoint in the execution, the programmer is provided visual feedback, and may control continuation of the execution. Further, error conditions that occur during execution of the program, commonly known as exceptions, will result in the execution being automatically paused for observation purposes. The programmer may modify a part of the program responsible for the exception and have an option to try again, meaning that a corrected part of the program is executed again to continue with execution of the program. Alternatively, the programmer may modify a region of the program (where an exception has occurred) in order to catch and handle the exception, and then allow program execution to continue so that the exception is handled as specified. Or, the programmer may specify that the exception be thrown from the containing method, and then allow the program execution to continue so that the exception can be caught and handled in the calling method, or continue to propagate up the execution stack.

Users may modify implementation of a dynamic class during execution, such as its set of declared instance variables (and their names, modifiers and initial values), its set of declared constructors (and their modifiers, parameters, local variables, and bodies), its set of declared methods (and their modifiers, parameters, local variables, bodies, and return statements), its set of view components (and their layout and connections), its declared controllers (and their local variables and bodies), and its declared behaviors (and their names, parameters, local variables, periodicities, termination conditions, and bodies).

These and other advantages of the present invention will be apparent to those skilled in the art from the foregoing specification. Accordingly, it is recognized by those skilled in the art that variations or modifications may be made to the above-described embodiment without departing from the broad inventive concepts of the invention. As earlier mentioned, it is therefore understood that this invention is not limited to the particular embodiment described herein, but is intended to include all possible variations and modifications within the scope and spirit of the invention, including adaptation to any underlying textual language.

What is claimed is:

1. A computer program embodied on a computer-readable medium for providing software development, the embodied program comprising:
a textual programming language; and
a language front-end supporting software development in a programming methodology of the textual language and providing a graphical programming environment permitting access to types of the textual programming language and permitting subtypes to be defined and modified dynamically (“dynamic types”) while the software under development is executing.

2. A computer program embodied on a computer-readable medium for providing software development, the embodied program comprising:
an object-oriented programming language; and
a language front-end supporting software development in a programming methodology of the object-oriented programming language and providing a graphical programming environment permitting access to classes of the object-oriented programming language and permitting subclasses to be defined and modified dynamically (“dynamic classes”) while the software under development is executing.

3. The computer program of claim 2, wherein modifications to the dynamic classes are reflected in future instances of the dynamic classes and in instances of the dynamic classes existing prior to the changes.

4. The computer program of claim 2, wherein the object-oriented programming language is Java.

5. The computer program of claim 2, wherein the dynamic classes coexist with compiled classes of the object-oriented programming language, the dynamic and the compiled classes each being capable of calling methods on instances of either of the dynamic or the compiled classes.

6. The computer program of claim 2, wherein dynamic classes may be created as subclasses of other dynamic classes or of compiled classes of the object-oriented programming language (“parent classes”) and may selectively override methods of the respective parent classes.

7. The computer program of claim 6, wherein the respective compiled classes are capable of calling methods on instances of the dynamic classes polymorphically, whereby overridden behavior is exhibited.

8. The computer program of claim 2, wherein upon creation of each dynamic class a respective peer class is automatically generated and compiled in the object-oriented programming language.

9. The computer program of claim 8, wherein the object-oriented programming language is Java and Java source code for each respective peer class is generated automatically, compiled into byte code by a Java compiler, and loaded into a Java interpreter upon creation of the respective dynamic class.

10. The computer program of claim 8, wherein the peer class overrides all methods of the parent class, whereby execution of any method overridden by the respective dynamic class is deferred to the dynamic class and execution of any method not overridden by the respective dynamic class is deferred to the parent class.

11. The computer program of claim 2, wherein the definition of and modifications to the dynamic classes includes a declaration of dynamically modifiable instance variables (“dynamic fields”) for retaining information within instances of the respective dynamic class.

12. The computer program of claim 2, wherein the definition of and modifications to the dynamic classes includes a declaration of dynamically modifiable constructors (“dynamic constructors”), with zero or more parameters, zero or more local variables, and zero or more statements for initializing information stored within instances of the respective dynamic class.

13. The computer program of claim 2, wherein the definition of and modifications to the dynamic classes includes a declaration of dynamically modifiable methods (“dynamic methods”), with zero or more parameters, zero or more local variables, and zero or more statements for operating upon information stored within instances of the respective dynamic class.

14. The computer program of claim 2, wherein the definition of and modifications to the dynamic classes includes construction of a view for graphically displaying information stored within instances of the respective dynamic class.

15. The computer program of claim 14, wherein the object-oriented programming language is Java and wherein constraints and an order for the view are automatically determined by generation of a rough layout by a programmer, wherein further options for the layout are provided and are selected from a group consisting of:
a regular grid, to determine a dimension and insertion order for Java's GridLayout;
aligned, to determine constraints for Java's GridBagLayout;
border, to determine center, north, south, east, and west components for Java's BorderLayout;
scaled layout, where component positions and sizes scale to fit a respective container; and
free form, where components are arranged exactly as specified by the programmer.

16. The computer program of claim 14, wherein the definition of and modifications to the dynamic classes includes defining relationships (“connections”) among components of the view, and between the components of the view and instance variables of the respective dynamic class.

17. The computer program of claim 14, wherein the definition of and modifications to the dynamic classes includes defining actions (“controllers”), the actions including steps carried out in response to events occurring within the view.

18. The computer program of claim 17, wherein a programmer demonstrates an event of interest by performing the event on a component of the view, and then selecting the event from a list of all recorded events.

19. The computer program of claim 2, wherein the definition of and modifications to the dynamic classes includes defining actions (“behaviors”), the actions having zero or more parameters and local variables, and having zero or more steps periodically executed by instances of the respective dynamic class.

20. The computer program of claim 19, further providing a modifiable expression to describe the period of execution, and a modifiable condition to describe when the period of execution ceases.

21. The computer program of claim 2, further implementing a visual representation providing for a viewing of modifications to the dynamic classes, wherein a textual syntax of the object-oriented programming language is hidden.

22. The computer program of claim 21, further implementing an interactive mechanism for use in conjunction with the visual representation in a process for defining and modifying the dynamic classes.

23. The computer program of claim 22, wherein the visual representation represents items selected from the class consisting of class, variable, constructor, method, controller, behavior, and parameter as a visual unit, the visual unit displaying a textual name of the item, showing scope of the item by visual cue, and indicating a data or return type of the item by graphical representation, and a name of the type of the item.

24. The computer program of claim 23, wherein the visual unit is a capsule, the visual cue is color, and the graphical representation is selected from the group consisting or an icon, popup text and an icon with popup text.

25. The computer program of claim 24, wherein statements and return values within a body of each constructor, method, controller and behavior are displayed as a chain of capsules and visually nested expressions.

26. The computer program of claim 24, wherein a name of each variable, constructor, method, controller, and behavior is updated directly on its respective capsule, and all capsules representing uses of the respective variable, constructor, method, controller and behavior have their textual names automatically updated.

27. The computer program of claim 22, wherein uses for each variable, constructor, method, controller, and behavior are delineated by selection from a list, or by dragging its respective capsule to an expression or chain within which it is to be used.

28. The computer program of claim 22, wherein creation of an instance variable causes automatic creation of appropriately named methods for getting and setting the value of the variable.

29. The computer program of claim 22, wherein changing a name of a variable causes a name of a method for getting and setting a value of the variable to be appropriately updated.

30. The computer program of claim 22, wherein, upon execution of the software under development, a programmer may control a speed of the execution and may receive visual feedback indicating a currently executing statement or expression within a context of its containing constructor, method, controller, or behavior.

31. The computer program of claim 30, where programmers may observe an execution stack for nested method calls and constructor calls, and may select any level of the execution stack to observe a currently executing expression within a context of its containing constructor, method, controller, or behavior.

32. The computer program of claim 30, where programmers may observe values produced by the most recent execution of each expression within a stack frame.

33. The computer program of claim 30, where programmers may specify points in the software under development (“breakpoints”), where execution automatically pauses for observation.

34. The computer program of claim 30, where error conditions occurring during execution of the software under development (“exceptions”) result in the execution being automatically paused for observation.

35. The computer program of claim 34, where programmers may modify a part of the software under development responsible for the exception, the programmers then having an option to try again, wherein the modified part of the software under development is executed again to continue with overall execution of the software under development.

36. The computer program of claim 34, where programmers may modify a region of the software under development responsible for the exception to catch and handle the exception, and to then allow execution to continue so that the exception is handled.

37. The computer program of claim 30, where programmers may modify an implementation of a dynamic class during execution, modification items being selected from a group consisting of declared instance variables, including names, modifiers and initial values, declared constructors, including their modifiers, parameters, local variables, and bodies, declared methods, including their modifiers, parameters, local variables, bodies, and return statements, view components, including their layout and connections, declared controllers, including their local variables and bodies, and declared behaviors, including their names, parameters, local variables, periodicities, termination conditions, and bodies.

38. A computer system comprising:
a central processing unit;
a memory having a software program development system, where modifications to a program under development take effect immediately while the program is executing; and
a graphical user interface supporting direct manipulation of semantic units of the program under development.

39. The computer system of claim 38, wherein changes to classes in the program under development are reflected in future instances of the classes and in instances of the classes existing prior to the changes.

40. A method of providing live software construction within an existing object-oriented programming language, the method comprising the steps of:
providing a graphical editor supporting direct manipulation of semantic units of a program under construction;
receiving a programmer definition of or modification to a subclass of a compiled class of an object-oriented programming language; and
executing the definition of or modification to the subclass of the compiled class in the object-oriented programming language while the program under construction is executing.

41. The method of claim 40, wherein modifications to subclasses in the program under construction are reflected in future instances of the subclasses and in instances of the subclasses existing prior to the modifications.

42. The method of claim 40, wherein the object-oriented programming language is Java.

43. The method of claim 40, wherein the subclasses coexist with the compiled classes, the subclasses and the compiled classes each being capable of calling methods on instances of either of the subclasses or the compiled classes.

44. The method of claim 40, wherein subclasses may be created within other subclasses or of compiled classes of the object-oriented programming language (“parent classes”) and may selectively override methods of the respective parent classes.

45. The method of claim 40, wherein upon creation of each subclass a respective peer class is automatically generated and compiled in the object-oriented programming language.
